(19) United States
(12) Patent Application Publication
(10) Pub. No.: US 2005/0229342 A1
(43) Pub. Date: Oct. 20, 2005

(54) Tractors for movement along a pipeline within a fluid flow

(76) Inventors: Neil Andrew Abercrombie Simpson, Grampian (GB); Susan Patricia D'Arcy, Aberdeenshire (GB)

Correspondence Address: William B Patterson;Moser Patterson & Sheridan, 3040 Post Oak Boulevard, Suite 1500, Houston, TX, 77056, US

(21) Appl. No.: 10/507,970

(22) PCT Filed: Mar. 17, 2003
(86) PCT No.: PCT/EP03/50065

§ 371 Date: Sep. 15, 2004

(30) Foreign Application Priority Data
Mar. 15, 2002 (GB) 0206246.1

(51) Int. Cl. B08B 9/055

(52) U.S. Cl. 15/104.061

(57) ABSTRACT

A tractor comprises a tractor module (10) coupled at opposite ends to a cleaning or inspection module (11) and a power generation module (12), the three modules being arranged in line within a pipeline (14) such that traction elements (15) on the tractor module (10) engage the wall of the pipeline (14). In operation within a pipeline along which fluid is flowing in the direction (16), drive is imparted to the power generation module (12) by the fluid flow, and the tractor module (10) is driven in the direction (17) by the power generation module (12) by way of a drive shaft (21) and appropriate step-down gearing (not shown). A speed governor is used to control the rotational speed of the drive shaft (21) such that the tractor speed is not directly related to the speed of the fluid flow, and is preferably substantially independent of the speed of the fluid flow. A tractor travelling at a constant and/or controlled speed is found to achieve better cleaining, or to enable more efficient inspections, than a tractor which is propelled along the pipeline at the rate of fluid flow in the pipeline.

This invention relates to tractors for movement along a pipeline within a fluid flow along the pipeline. The term “tractor” is used in this specification to denote any type of pig, tractor or other device for movement along pipeline within a fluid flow.

In the oil and gas exploration and extraction industry, there is widespread use of subsurface and subsea conduits, often of extended lengths. For example subsea pipelines may extend for many kilometres between subsea wellheads and support platforms, and between production platforms and onshore facilities. Over time, there tends to be build-up of material on the inner walls of such pipelines which may include wax, scale and various precipitates. Of course, such a build-up of material will reduce the flow capacity of the pipeline, and may result ultimately in the pipeline becoming blocked.

Conventionally such pipelines are periodically cleaned by passing a pig through the pipeline, with the pig being launched into the pipeline at an appropriate upstream point, which may require production to be temporarily stopped. A pig is typically of cylindrical form, of slightly smaller diameter than the pipeline, and is carried through the pipeline by the flow of fluid in the pipeline. Dislodged material therefore builds up in front of the pig, and it is accordingly not unusual for pigs to become stuck in pipelines, which may bring production to a halt. Retrieval of a stuck pig requires the pig to be located, the pipeline opened to remove the pig, and the pipeline reinstated, which is both an expensive and difficult undertaking.

It is an object of the invention to provide a tractor for movement along a pipeline within the fluid flow along the pipeline which renders it less likely that material will build up within the pipeline in such a manner as to block the passage of the tractor along the pipeline.

According to one aspect of the present invention there is provided a tractor for movement along a pipeline within a fluid flow along the pipeline, the tractor comprising propulsion means propelling the tractor along the pipeline in the direction of the fluid flow at a speed which is not directly related to the speed of the fluid flow.

According to another aspect of the invention there is provided a tractor for movement along a pipeline within a fluid flow along the pipeline, the tractor comprising speed regulated propulsion means for propelling the tractor along the pipeline in the direction of the fluid flow at a regulated speed.

According to another aspect of the invention there is provided a tractor for movement along a pipeline within a fluid flow along the pipeline, the tractor incorporating a geared braking mechanism for controlling the speed of the tractor along the pipeline in the direction of fluid flow.

In a pipeline containing gas or gas and fluid a conventional pig will travel along the pipeline at a variable speed in dependence on variations in the pressure of the gas and/or flow variations caused by slugging of a two-phase flow. By contrast the tractor of the invention travels along the pipeline at a constant and/or controllable speed, and this is beneficial in terms of allowing efficient cleaning of the pipeline (where the device is used for pipeline cleaning) or in regulating the speed of inspection operations (where the device is used for inspection of the pipeline). A tractor travelling at a constant and/or controlled speed is found to be more effective and to achieve better cleaning than a tractor which is propelled along the pipeline at the rate of fluid flow in the pipeline.

Further optional features of the invention are set out in the accompanying sub-claims.

In order that the invention may be more fully understood, several embodiments in accordance with the invention will now be described, by way of example, with reference to the accompanying drawings, in which:

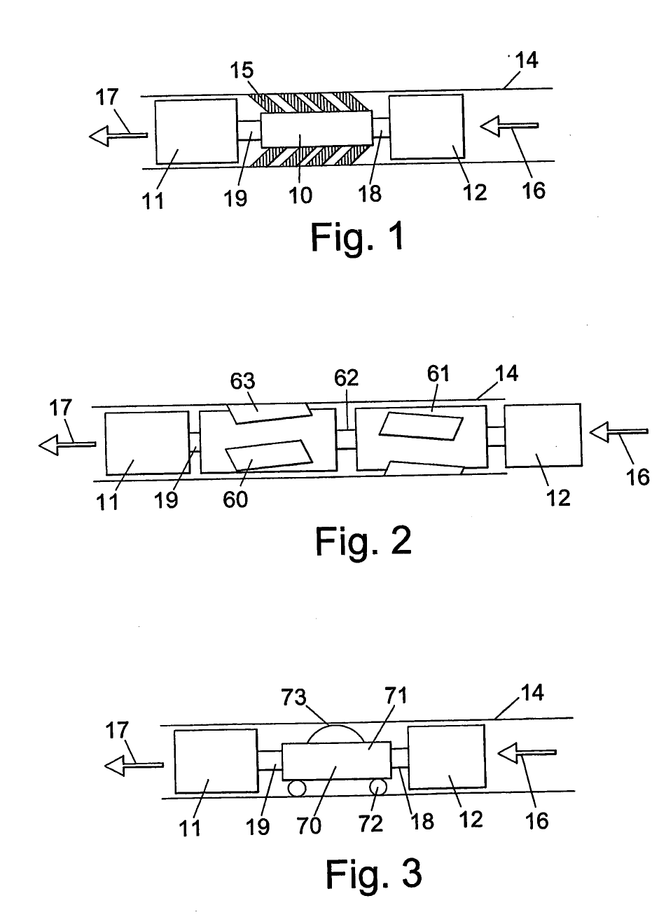

FIGS. 1 to 3 schematically show three different embodiments in accordance with the invention within a pipeline; and

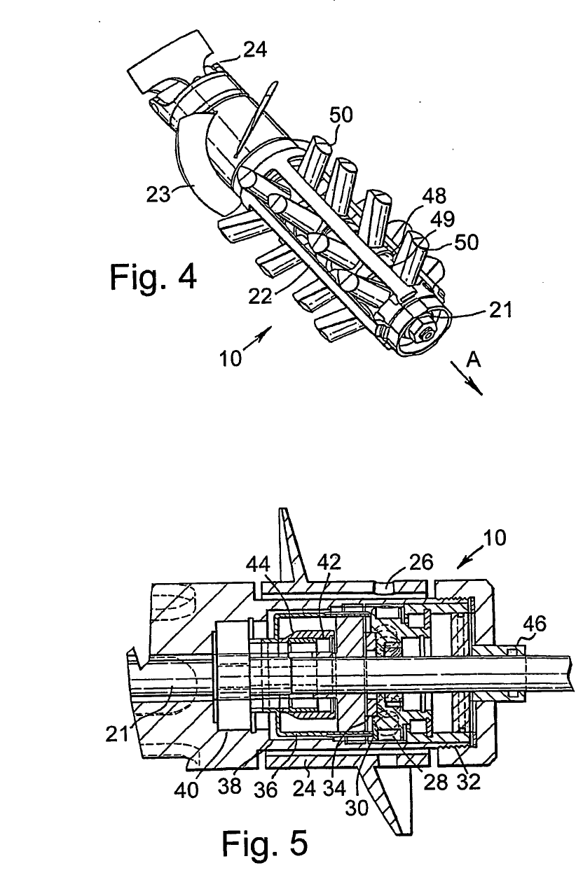

FIGS. 4 and 5 show respectively a perspective view and an axial section of part of the arrangement of FIG. 1.

Various tractor arrangements for movement along a pipeline within a fluid flow are described in Patent Publications WO 98/06927, WO 00/73619 and WO 01/18351, and similar arrangements may be used with appropriate modifications in accordance with the invention. Such modifications involve regulation of the speed at which the tractor is propelled along the pipeline such that the tractor speed is not directly related to the speed of the fluid flow, and is preferably substantially independent of the speed of the fluid flow, as described in more detail below. It should be understood that the arrangements described in these prior publications are incorporated herein by reference.

In a first embodiment of the invention, shown diagrammatically in FIG. 1, a tractor module 10 is coupled at opposite ends to a cleaning or inspection module 11 and a power generation module 12, the three modules being arranged in line within the pipeline 14 such that traction elements 15 on the tractor module 10 engage the wall of the pipeline 14. The flow of fluid along the pipeline 14 is indicated by an arrow 16, whereas the direction of travel of the tractor is indicated by the arrow 17. In operation within the pipeline drive is imparted to the power generation module 12 by the fluid flow, and the tractor module 10 is driven by the power generation module 12 by way of a coupling 18 and appropriate step-down gearing (not shown). Power may also be supplied to the cleaning or inspection module 11 by the tractor module 10 or the power generation module 12 by way of a further coupling 19.

The tractor module 10 is shown in more detail in FIG. 4 from which it will be seen that the module comprises a generally cylindrical housing 22, the power generation module 12 incorporating a turbine 23 having a cylindrical sleeve 24 which is mounted on the housing 22 coaxially with a drive shaft 21. The sleeve 24 provides mounting for a number of magnets 26 which interact with opposite pole magnets 28 mounted on a flywheel 30 within the housing 22, as may be seen in the axial section of FIG. 5. The magnets 26, 28 are arranged to provide inductive coupling through an intervening non-magnetic body portion. Thus the magnets 26, 28 provide a contactless coupling and avoid the need to provide seals and the like between the turbine 23 and the housing 22. The flywheel 30 is coupled to a gearbox 25, which is in the form of a harmonic drive. Alternatively drive may be imparted from the turbine 23 to the drive shaft 21 by way of a direct drive gearbox. For example the turbine 23 may have a gear wheel on its inner diameter which drives gear wheels protruding through the wall of the housing 22. In this event seals at either end of the turbine allow the turbine bearings to be lubricated and not exposed to the fluid in the pipeline.

A speed governor is used to control the rotational speed of the drive shaft 21 or a traction wheel. For example a brake type centrifugal governor may be used to control the speed. In this case a brake shoe is used as the flyweight and restrained by a spring force. As the speed is increased the brake shoe comes into contact with the housing and slows the drive shaft down.

The traction module 10 includes a plurality of traction elements 22 each of which comprises a bush from which resilient fingers 50 extend, the bush being mounted on an off-axis bearing 48 such that rotation of the axial shaft 21 causes the fingers 50 to be oscillated backwards and forwards relative to the pipeline wall as described in WO 98/06927. Such oscillation of the fingers 50 varies the traction provided by the traction elements such that the tractor module 10 is propelled along the pipeline by the contact of the fingers 50 with the wall of the pipeline. By moving of the fingers 50 from one side of the bearing centre line to the other it is possible to reverse the direction of traction, to facilitate movement of the tractor in the opposite direction to the original drive direction.

In operation of such an arrangement the tractor is launched from the wellhead, or from an upstream position, into the pipeline in a similar manner to a conventional pig. However the power generation module 12 is driven by the fluid flow in the pipeline to generate power, and this power is then used to operate the tractor module 10 so that the tractor module 10 is positively driven in the direction of travel, rather than simply relying on pressure of the fluid flow to propel the tractor along the pipeline. Thus, because the tool is caused to travel along the pipeline at a controlled rate, the speed of propulsion is not dictated by the speed of fluid flow in the pipeline. Furthermore the power generated within the power generation module 12 may be used to operate auxiliary modules, such as the cleaning or inspection module 11, and may also enable power to be stored for alternative use. The speed of travel of the tractor module 10 is controlled by a speed governor or electronic speed control.

The traction elements of the tractor module 10 may alternatively be brush-type traction elements as used in the embodiments of FIGS. 3, 4a, 4b and 4c of WO 98/06927, in which case the brushes may be positioned to brake the module against the fluid pressure whilst allowing the traction module 12 to be propelled forwardly at a controlled rate by the power supplied by the power generation module 12.

FIG. 2 shows a further embodiment of the invention in which the same reference numerals are used to denote similar parts as in FIG. 1. In this case two tractor modules 60 and 61 are coupled back-to-back by a mesh braking gear 62 and reduction gearing, each of the modules 60 and 61 incorporating traction elements in the form of rollers 63 for engaging the wall of the pipeline 14 to impart traction in the manner described with reference to FIGS. 3, 4a, 4b and 4c of WO 98/06927. As a result of the arrangement of the traction elements on the tractor modules 60 and 61 and the coupling mesh gear 62, the tractor modules 60 and 61 are rotated in different directions and at different speeds, and this causes braking of the travel of the tractor so as to ensure that the tractor travels along the pipeline at a controlled speed substantially independent of the speed of fluid flow along the pipeline.

FIG. 3 shows a still further embodiment of the invention in which similar parts are denoted by the same reference numerals as in FIGS. 1 and 2. In this case the tractor module 70 comprises a body 71 having sprung members 72, and a wheel 73 for bearing against the wall of the pipeline to maintain the wheel 73 in rolling engagement with the pipeline wall. In this case the drive to the wheel 73 may be directed by way of gearing from a spinning device driven by the power generation module 12, or alternatively the wheel 73 may be braked by hydraulic, mechanical, magnetic or electrical means so as to control the speed of travel of the tractor.

The embodiments of FIGS. 1 and 3 provide a large bypass area by means of which the fluid flow within the pipeline may pass beyond the tractor, and this is advantageous in assisting controlled driving of the tractor independently of the speed of fluid flow. The embodiment of FIG. 2 has channels machined along the length of the body to increase the flow area past it.

It will be appreciated that the above described embodiments fall into two broad categories, namely (i) embodiments in which the traction elements (fingers, rollers or wheels) are overdriven by the power generation module and are simultaneously braked by a braking arrangement that can be controlled to vary the speed, and (ii) embodiments in which the traction elements (fingers, rollers or wheels) are driven by the power generation module by way of drive arrangement that is controllable to vary the speed. In the latter case the controllable drive arrangement may be in the form of turbine blades having angles that may be varied to change the rotational speed at which the turbine is driven in a fluid flow. In this case the arrangement includes a control system for actuating the turbine blades of the power generation module by axial displacement of a central actuating rod so as to alter the angle that all the blades make with the central axis to change the speed of turbine rotation independently of the fluid flow so as to vary the speed of movement of the tractor along the pipeline.

Alternately, in an arrangement such as that shown in FIG. 4 in which the tractions elements are in the form of resilient fingers or brushes extending outwardly from an eccentrically mounted central bush, the controllable drive arrangement may be in the form of a central control rod that may be axially displaced in order to change the angle that the fingers or brushes make with the central axis so as to change the length of the “steps” taken by the fingers in contact with the pipeline wall and to thereby alter the speed at which the tractor is moved along the pipeline independently of the fluid flow. In the event that the angle of the fingers or brushes is moved back beyond the bearing centre line the tractor is caused to move in the opposite direction, as already referred to above.

In a further non-illustrated embodiment the power generation module is coupled to the traction module by way of a series of epicyclic gear boxes and braking gear boxes which are switchable between different speed ratios by an associated control system.

The above described embodiments of the invention possess a number of advantages in practice in that they generate power from the fluid flow in the pipeline and use this power for controlled driving of the tractor independently of the pressure of the fluid imparting drive. This enables the speed of inspection operations to be regulated and/or more effective cleaning operation. The invention solves the problem of the intermittent travel of conventional pigs along a pipeline by using a tractor as a speed regulator so that the force of the fluid in the pipeline does not directly control the speed of travel. The pressure drop across the tool is significantly less than that across a conventional pig so that the pressure force pushing the tool is significantly less than in conventional pigging operation.

Various modifications of the above described embodiments are possible within the scope of the invention. For example the cleaning or inspection module may be provided with its own dedicated power unit for generating the power required for the module from the fluid flow. Furthermore, when the arrangement is used for cleaning, an additional scrubbing unit may be incorporated to ensure better cleaning.

1. A tractor for movement along a pipeline within a fluid flow along the pipeline, the tractor comprising propulsion means for propelling the tractor along the pipeline in the direction of the fluid flow at a speed which is not directly related to the speed of the fluid flow.

2. A tractor for movement along a pipeline within a fluid flow along the pipeline, the tractor comprising speed regulated propulsion means for propelling the tractor along the pipeline in the direction of fluid flow at a regulated speed.

3. A tractor according to claim 1 or 2, wherein the propulsion means includes speed regulating means for regulating the speed at which the tractor is propelled along the pipeline to a speed which is substantially independent of the speed of the fluid flow.

4. A tractor according to claim 3, wherein the speed regulating means incorporates braking means for braking the tractor by engagement with a wall of the pipeline.

5. A tractor according to claim 2 or 3, wherein the speed regulating means incorporates a speed governor for controlling the speed at which traction means engaging a wall of the pipeline is driven.

6. A tractor according to any preceding claim, wherein the propulsion means is driven by driving means adapted to be driven by the fluid flow.

7. A tractor according to claim 6, wherein the driving means is a turbine.

8. A tractor according to claim 7, wherein the turbine incorporates variable blade means, and the speed regulating means is arranged to vary the speed at which the tractor is propelled along the pipeline by changing the angle of the blade means with respect to a central axis.

9. A tractor according to claim 7 or 8, wherein the driving means is coupled to the propulsion means by conversion means which is adjustable to vary the degree of coupling between the propulsion means and the drive means.

10. A tractor according to claim 9, wherein the conversion means comprises a magnetic coupling.

11. A tractor according to claim 10, wherein the coupling comprises driving and driven elements which are relatively axially movable.

12. A tractor according to claim 9, 109 or 11, wherein the conversion means comprises reduction gearing for converting a high speed low torque input from the propulsion means to a relatively low speed high torque output to the drive means.

13. A tractor according to claim 9, 10, 11 or 12, wherein the conversion means comprises a harmonic drive.

14. A tractor according to any preceding claim, wherein the propulsion means incorporates a plurality of traction elements for engaging a wall of the pipeline, and drive means for driving the traction elements to move the tractor along the pipeline.

15. A tractor according to claim 14, wherein the traction elements are wheels which are driven in rolling engagement with the wall of the pipeline.

16. A tractor according to claim 14, wherein the traction elements are outwardly extending legs or brushes which are driven backwards and forwards relative to the wall of the pipeline to effect propulsion of the tractor in the required direction along the pipeline.

17. A tractor according to claim 15, wherein the angular orientation of the traction elements with respect a central axis is adjustable, and the speed regulating means is arranged to vary the speed at which the tractor is propelled along the pipeline by changing the angle of the traction elements with respect to the central axis.

18. A tractor according to claim 16 or 17, wherein the traction elements are mounted on eccentric bearing means.

19. A tractor according to any one of claims 14 to 18, wherein the drive means comprises a rotatable shaft extending generally axially within the pipeline.

20. A tractor according to any one of claims 14 to 19, wherein braking means are provided for braking the traction elements in order to control the rate at which the tractor is propelled along the pipeline.

21. A tractor according to claim 20, wherein the braking means comprises a disc braking system.

22. A tractor according to any one of claims 14 to 21, wherein the propulsion means incorporates two traction units incorporating traction elements for engaging the wall of the pipeline and adapted to be driven by the drive means such that the traction units are biased to act in opposite directions.

23. A tractor according to claim 22, wherein control means are provided for controlling the rate at which the traction elements of the two traction units are driven relative to one another so as to regulate the speed at which the tractor is propelled along the pipeline.

24. A tractor according to any preceding claim, wherein a fluid bypass is provided for permitting fluid flow along the pipeline past the tractor.

25. A tractor according to any preceding claim, wherein cleaning means is provided for removing or dislodging material from a wall of the pipeline.

26. A tractor according to any preceding claim, wherein jetting means is provided to direct jets of fluid onto a wall of the pipeline for removing or dislodging material from the wall.

27. A tractor according to any preceding claim, wherein cutting means is provided for removing or dislodging material from a wall of the pipeline.

28. A tractor according to any preceding claim, wherein inspection means is provided for inspecting a wall of the pipeline.

29. A tractor for movement along a pipeline within a fluid flow along the pipeline, the tractor incorporating a geared braking mechanism for controlling the speed of the tractor along the pipeline in the direction of fluid flow.
